(19) United States
(12) Patent Application Publication
(10) Pub. No.: US 2012/0060043 A1
(43) Pub. Date: Mar. 8, 2012

(54) APPARATUS AND METHOD FOR CONTROLLING POWER IN A WIRELESS COMMUNICATION SYSTEM

(75) Inventors: Deok-Hwan KIM, Anseong-si (KR); Seong-Wook SONG, Gwacheon-si (KR)

(73) Assignee: SAMSUNG ELECTRONICS CO. LTD., Suwon-si (KR)

(21) Appl. No.: 13/224,687

(22) Filed: Sep. 2, 2011

(30) Foreign Application Priority Data
Sep. 3, 2010 (KR) 10-2010-0086597

(51) Int. Cl. G06F 1/32

(52) U.S. Cl. 713/320

(57) ABSTRACT

An apparatus and method for controlling power in a wireless communication system are provided. The method includes determining one or more available communication modes based on at least one of suppliable power information and data bit rate information, setting one of the one or more determined available communication modes as a communication mode during negotiation of a communication mode with a base station, and transmitting and receiving data by applying the set communication mode.

### PRIORITY

This application claims the benefit under 35 U.S.C. §119(a) of a Korean patent application filed in the Korean Intellectual Property Office on Sep. 3, 2010 and assigned Serial No. 10-2010-0086597, the entire disclosure of which is hereby incorporated by reference.

### BACKGROUND OF THE INVENTION

1. Field of the Invention

The present invention relates to a wireless communication system. More particularly, the present invention relates to an apparatus and method for controlling power in a wireless communication system.

2. Description of the Related Art

Mobile communication technology has evolved from the early mobile communication terminals that primarily supported voice services into advanced mobile communication terminals capable of supporting multimedia services, to which a variety of features are added.

Recently, Internet services, broadcast services, video mail services, etc. may be provided on mobile communication terminals, and additional devices such as an MP3 player and a digital camera are installed in the mobile communication terminals to allow users to listen to music and take pictures using the mobile communication terminals. With the growing diversity of the features of the mobile communication terminals, there is an increasing demand for high-speed data transmission in high-power mobile communication systems.

Due to the increasing demand for high-speed data transmission in mobile communication systems, many new communication techniques have been introduced such as a communication technique for applying multiple antennas to a base station and a mobile communication terminal, and another communication technique for adaptively changing an encoding rate and a modulation order for information depending on the channel condition between a base station and a mobile communication terminal.

A data bit rate of a mobile communication terminal, unlike that of a wired communication device, significantly depends on the channel environment. If the channel environment is poor, many errors may occur in received data, causing an increase in decoding failure. Besides, as many errors may occur in received data, additional overhead may occur for data retransmission, reducing data throughput. The encoding rate and modulation order for data transmitted by a transmitter may significantly affect a decoding rate at a receiver. If the encoding rate and the modulation order are low, throughput of the data transmitted per unit time is reduced, but the decoding rate is improved, preventing overhead for data retransmission and thus contributing to an increase in data bit rate. Based on these characteristics, a Core Network (CN) and a Radio Network Controller (RNC) may negotiate a data bit rate to maintain Quality-of-Service (QoS) of the network, and the RNC maintains the data bit rate by adaptively adjusting the encoding rate and modulation order to be used for communication with mobile communication terminals.

After setting a communication mode in this way, the RNC adjusts the encoding rate and modulation order by adaptively adjusting the communication mode over time taking into account the power consumption of a transmission unit in a mobile communication terminal and the channel condition between the mobile communication terminal and the base station. For example, if a transmission error rate of the mobile communication terminal is greater than or equal to a specific level, the RNC adjusts the communication mode by reducing the modulation order and/or the encoding rate, determining that the channel condition is poor. However, if the power consumption of the transmission unit is greater than or equal to a specific level, the RNC adjusts the communication mode by reducing the modulation order and/or encoding rate, determining that the mobile communication terminal can no longer transmit reply information for the data received from the base station, to the base station at a high rate.

However, these techniques for adjusting the communication mode may not adjust a multi-antenna configuration mode, which accounts for a large amount of the total power consumption, because they adaptively adjust only the encoding rate and/or modulation order for information taking into account only the channel condition, maintenance of the network QoS, and the transmit power consumption. Thus, the mobile communication terminal may select an unavailable communication mode before it completes its initial connection to the base station.

### SUMMARY OF THE INVENTION

Aspects of the present invention are to address the above-mentioned problems and/or disadvantages and to provide at least the advantages described below. Accordingly, an aspect of the present invention is to provide an apparatus and method in which a modem may acquire information about the maximum available power and information about the maximum transfer rate from a host in advance before a mobile communication terminal negotiates a communication mode with a base station.

Another aspect of the present invention is to provide an apparatus and method for allowing a mobile communication terminal and a base station to select an available communication mode by negotiating over a communication mode.

Another aspect of the present invention is to provide an apparatus and method for blocking a mobile communication terminal and a base station from selecting an unavailable communication mode by negotiating over a communication mode.

Another aspect of the present invention is to provide an apparatus and method capable of reducing power consumption of a modem by dynamically restricting a communication mode of the modem depending on the situation of a host.

In accordance with an aspect of the present invention, a method for controlling power in a wireless communication system is provided. The method includes determining one or more available communication modes based on at least one of suppliable power information and data bit rate information, setting one of the one or more determined available communication modes as a communication mode during negotiation of a communication mode with a base station, and transmitting and receiving data by applying the set communication mode.

In accordance with another aspect of the present invention, an apparatus for controlling power in a wireless communication system is provided. The apparatus includes a host for transmitting at least one of suppliable power information and data bit rate information to a modem, and the modem for determining one or more available communication modes based on at least one of the transmitted suppliable power information and data bit rate information, for setting one of the one or more determined available communication modes as a communication mode during negotiation of a communication mode with a base station, and for transmitting and receiving data by applying the set communication mode.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an operation of negotiating a communication mode with a base station by a mobile communication terminal according to the related art;

FIG. 2 illustrates a structure of a mobile communication terminal according to an exemplary embodiment of the present invention;

FIG. 3 illustrates a process of determining a communication mode by a mobile communication terminal according to an exemplary embodiment of the present invention; and

FIG. 4 illustrates a signaling operation during negotiation of a communication mode with a base station by a mobile communication terminal according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

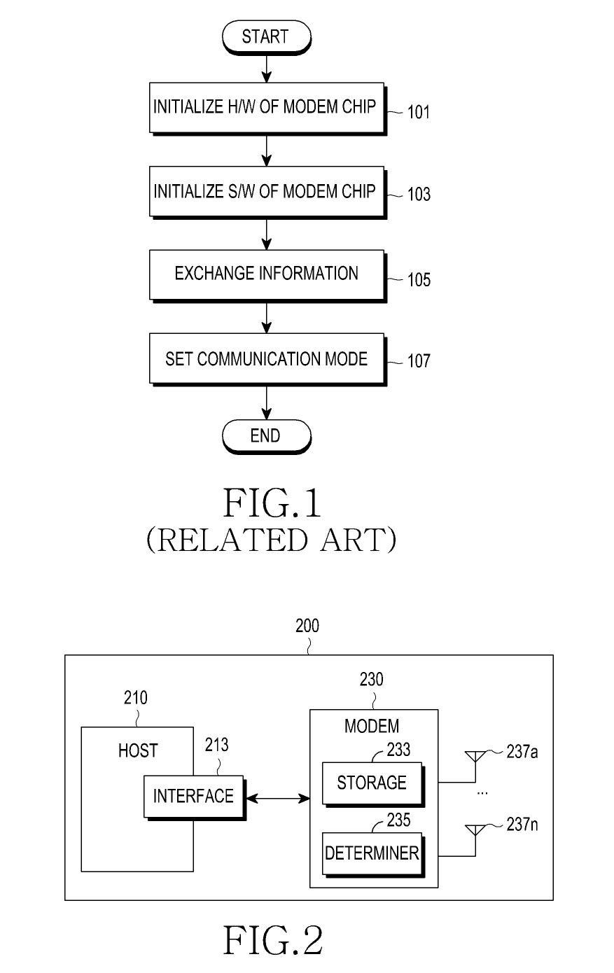

FIG. 1 illustrates an operation of negotiating a communication mode with a base station by a mobile communication terminal according to the related art.

Referring to FIG. 1, if the mobile communication terminal is powered on, hardware (H/W) of the mobile communication terminal is initialized in step 101 and software (S/W) for controlling the mobile communication terminal is started through a booting process in step 103. A modem of the mobile communication terminal exchanges information about a communication mode with a base station in step 105, and sets an optimal communication mode appropriate to their situations in step 107. More specifically, the modem of the mobile communication terminal and the base station determine one communication mode among at least one preset communication mode(s), and transmit/receive data according to the determined communication mode. Among the at least one preset communication mode(s), each communication mode is different in terms of maximum consumption power. The mobile communication terminal transmits information about its maximum capability at which the mobile communication terminal can communicate, such as category information determined by the number of receive antennas and/or the maximum data throughput, to the base station according to a preset protocol. Based on the information received from the mobile communication terminal, the base station sets a communication mode whose capability does not exceed the maximum capability designated in the received information, and communicates with the mobile communication terminal according to the set communication mode.

In this case, the modem of the mobile communication terminal may select a communication mode in which its operation is impossible due to the lack of power, in a process of negotiating a communication mode with the base station. In the case of a modem whose host is not specifically designated and changed depending on the situations, such as a Universal Serial Bus (USB) dongle, its malfunction possibility is much higher. With the growing increase in data throughput, data throughput in the existing interface may be less than the increasing data throughput. In this case, power may be consumed unnecessarily, as multiple antennas are used for unnecessary high-speed data transmission.

The amount of power consumed by the mobile communication terminal significantly depends on the multi-antenna configuration formed between the mobile communication terminal and the base station, or on the communication mode. More particularly, when the multi-antenna technique is used, many analog modules such as Radio Frequency (RF) modules are used, significantly increasing power consumption. If the amount of power supplied to the modem through an interface is less than the amount of power consumed in the modem, the modem may not normally communicate with the base station.

The modem often uses an interface such as a USB and a Peripheral Component Interconnect (PCI)-Express, for data exchange with the host, and the possible maximum power may be different depending on the type or situation of the interface of the host. For example, the popularly-used USB2.0 interface may support power as much as a maximum of 500 mA, while a USB3.0 interface may support power as much as a maximum of 900 mA. If a mobile communication system uses multiple antennas, the power consumption may significantly increase not only in a digital part but also in an analog part of the modem, so the amount of power consumed in the mobile communication terminal differs significantly depending on the number of antennas in use. In some situations, the power consumed in the modem may not be sufficiently supplied by the host. For example, if the modem consumes a current greater than 500 mA and less than 900 mA as operation power in a communication mode where four receive antennas are used, among various communication modes supported by the modem, the modem may operate in USB3.0 but does not operate in USB2.0. Therefore, a control scheme is required in which a modem may determine a communication mode in which its normal operation is possible in the current power supply situation and may negotiate only this communication mode with the base station, even though the modem may operate in all of the various communication modes.

Due to the development of technology for high-speed data transmission, the recently announced Long Term Evolution Advanced (LTE-A) supports a downlink rate of a maximum of 1 Gbps, whereas the USB2.0 interface most popularly used in the existing host does not meet the downlink rate because its maximum data bit rate is only 480 Mbps. When the multi-antenna technique is used to support the high downlink rate, a large amount of power is consumed. However, when the data bit rate of the interface is low like this, it is not necessary to use a large number of antennas. Therefore, the modem is required to determine data bit rates of these interfaces in advance, and perform communication in a communication mode whose data bit rate does not exceed its maximum data bit rate, thereby saving power.

Therefore, exemplary embodiments of the present invention allow a mobile communication terminal and a base station to select an available communication mode by negotiation of a communication mode. By doing so, exemplary embodiments of the present invention block the mobile communication terminal and the base station from selecting an unavailable communication mode, thereby preventing an abnormal operation of the modem, and also dynamically reset a communication mode depending on the type and/or situation of the host, thereby saving power.

FIG. 2 illustrates a structure of a mobile communication terminal according to an exemplary embodiment of the present invention.

Referring to FIG. 2, a mobile communication terminal 200 includes a host 210, a modem 230, and an interface 213 connecting the host 210 to the modem 230.

The host 210 supplies power to the modem 230 through the interface 213. The possible maximum power is different depending on the type of the interface 213 and the situation of the host 210.

The modem 230 includes a storage 233, a determiner 235, and multiple antennas 237a to 237n. The determiner 235 may be realized by either H/W or S/W. The modem 230 is supplied power from the host 210 through the interface 213, and transmits, to the host 210, the data generated by decoding signals received from a base station. The modem 230 acquires information about suppliable power from the host 210 and determines communication modes in which its normal operation is possible, based on the information. During negotiation of a communication mode with the base station, the modem 230 may set any one of the determined communication modes as the communication mode. Upon receiving a communication mode change request from the host 210, the modem 230 resets the communication mode at the request of the host 210.

In setting or resetting a communication mode, the modem 230 may not use some of the multiple antennas 237a to 237n, and block the power supplied to the unused antennas.

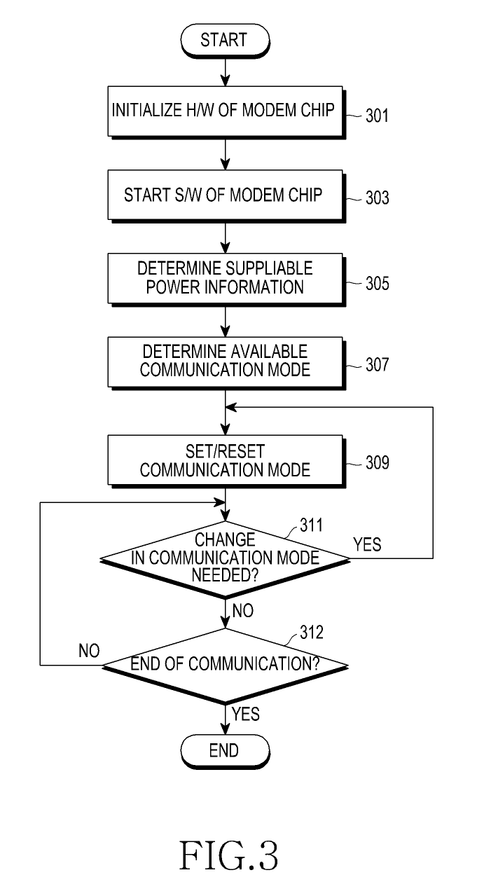

FIG. 3 illustrates a process of determining a communication mode by a mobile communication terminal according to an exemplary embodiment of the present invention.

Referring to FIG. 3, if the mobile communication terminal is powered on, H/W of the mobile communication terminal is initialized in step 301 and S/W for controlling the mobile communication terminal is started through a booting process in step 303. In step 305, a modem of the mobile communication terminal receives and determines information about suppliable power from a host. In step 307, the modem determines a communication mode, in which its normal operation is possible, from among at least one preset communication mode depending on the determined information about suppliable power.

In step 305, the modem of the mobile communication terminal may receive data bit rate information for an interface from the host along with power information. In step 307, the modem may determine a communication mode based on the received data bit rate information.

Thereafter, during negotiation of a communication mode with the base station, the modem of the mobile communication terminal allows the base station to select an optimal communication mode taking into account only the communication mode determined in step 307. In step 309, the modem sets a communication mode selected by the base station and transmits/receives data in the set communication mode.

Thereafter, upon receiving a communication mode change from the host, the modem of the mobile communication terminal resets the communication mode in response to the communication mode change request in step 309.

In step 311, the modem determines if there is a need to change the communication mode. If not, the modem periodically determines in step 312 whether its communication has been completed. If not, the modem returns to step 311. However, if commanded to end the communication, the modem ends the communication in response to the communication end command.

In resetting the communication mode after the communication mode was restricted by the supplied power as described above, the modem may determine whether to change the communication mode depending on the situations of the mobile communication terminal, such as the transfer rate of the interface and the battery status of the host.

In other words, if the transfer rate for data exchange with the host through the interface is not greater than the transfer rate for data exchange with the base station, the modem is not required to connect with the base station using the communication mode supporting a high transfer rate. In this case, the modem may select a communication mode in which the power consumption is low, even though the data bit rate is lower than the current data bit rate. To this end, the modem limits the communication mode with the base station to the communication mode having a data bit rate most similar to the data bit rate of the interface.

To acquire information about suppliable power and/or information about a data bit rate, the modem may use the following two schemes.

First, the modem may acquire information about suppliable power and/or information about a data bit rate by identifying the type of an interface between the modem and the host. As for interfaces between the modem and the host, the different types of interfaces may be different not only in possible maximum power but also in maximum transfer rate, and even the same types of interfaces may be different in possible maximum power and maximum transfer rate depending on their release versions. Therefore, the storage 233 in the modem 230 should store in advance the possible maximum power information defined in Table 1 and the maximum transfer rate information defined in Table 2. The determiner 235 determines the possible maximum power (or suppliable power) information and/or the maximum transfer rate (or data bit rate) information based on the information defined in Tables 1 and 2 and stored in the storage 233.

TABLE 1
Possible Maximum Power Information

| | | | Possible maximum |
|---|---|---|---|
| Interface | Release version | Power rail (V) | power (mA) |
| USB | 2.0 | | 500 |
| | 3.0 | | 850 |
| PCI Express Mini | 1.0 | 3.3 | 1000 |
| | 1.0 | 1.5 | 500 |
| . . . | . . . | . . . | . . . |

TABLE 2
Maximum Transfer Rate Information

| Interface | Release version | Data throughput (Mbps) |
|---|---|---|
| USB | 1.1 | 12 |
| | 2.0 | 480 |
| | 3.0 | 4800 |
| . . . | . . . | . . . |

Second, the modem may acquire the suppliable power information and/or the data bit rate information using a protocol predetermined for communication with the host. The modem 230 sends a request message for requesting suppliable power information and/or data bit rate information to the host 210, and receives a response message including suppliable power information and/or data bit rate information from the host 210 in response to the request. The response message is generated by the host 210 based on the type of the interface 213, the battery status, and the operation status of the mobile communication terminal. In this manner, the host 210 may select proper suppliable power information and/or data bit rate information depending on the situations, and deliver the selected information to the modem 230.

Thereafter, the determiner 235 in the modem 230 determines a communication mode in which the modem 230 may operate normally in the current power supply situation, based on the suppliable power information acquired using any one of the above two schemes, and on information about the amount of consumed power for individual communication modes as defined in Table 3 below.

TABLE 3

| Communication mode | Power consumption (mW) |
|---|---|
| Communication mode #1 | 230 |
| Communication mode #2 | 320 |
| . . . | . . . |

The determiner 235 in the modem 230 determines a communication mode in which the modem 230 may operate normally in the current data bit rate situation, based on the data bit rate information acquired using any one of the above two schemes, and on information about the maximum transfer rates for individual communication modes as defined in Table 4 below.

TABLE 4

| Communication mode | Maximum transfer rate (Mbps) |
|---|---|
| Communication mode #1 | 10 |
| Communication mode #2 | 50 |
| . . . | . . . |

During negotiation of a communication mode with a base station by a mobile communication terminal, by limiting the communication mode to the determined communication mode, the mobile communication terminal may perform a normal operation regardless of which communication mode the base station selects and sets.

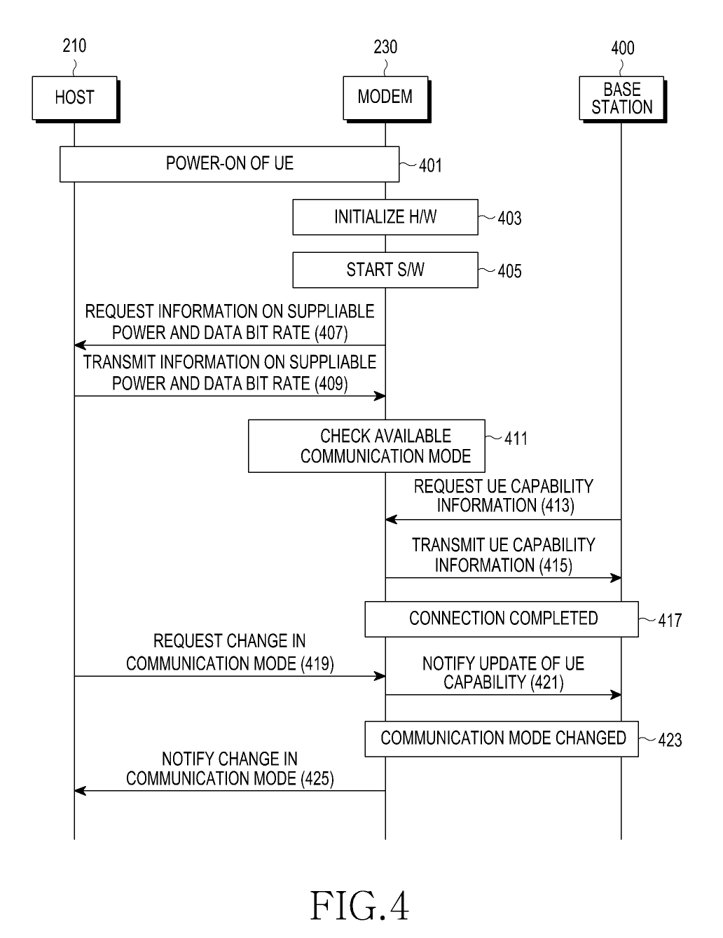

FIG. 4 illustrates a signaling operation during negotiation of a communication mode with a base station by a mobile communication terminal according to an exemplary embodiment of the present invention.

Referring to FIG. 4, if the mobile communication terminal (or User Equipment (UE)) 200 is powered on in step 401, the modem 230 of the mobile communication terminal 200 initializes its H/W in step 403, and starts its S/W in step 405. In step 407, the modem 230 requests suppliable power information and data bit rate information from the host 201. In step 409, the host 210 transmits the suppliable power information and data bit rate information to the modem 230 in response to the request. In step 411, the modem 230 determines a communication mode in which its normal operation is possible, from among at least one preset communication mode based on the suppliable power information and data bit rate information transmitted from the host 210.

For example, if category information as defined in Table 5 below is stored in the storage 233 of the modem 230, the suppliable power from the host 210 is 500 mA, and the data bit rate is 480 Mbps, the modem 230 determines the communication mode, in which its normal operation is possible, corresponds to a category #3, and stores it in the storage 233.

TABLE 5

| | Possible maximum | Maximum transfer | Number of |
|---|---|---|---|
| UE category | power (mA) | rate (Mbps) | antennas |
| category #1 | 230 | 10 | 1 |
| category #2 | 340 | 50 | 2 |
| category #3 | 380 | 100 | 2 |
| category #4 | 510 | 150 | 2 |
| category #5 | 680 | 300 | 4 |

Thereafter, during negotiation of a communication mode with the base 400 station by the mobile communication terminal, upon receiving a request for UE capability information from the base station 400 in step 413, the modem 230 transmits the UE capability information to the base station 400 in response to the request in step 415. The transmitted UE capability information indicates the communication mode determined in step 411, in which the modem 233 may operate normally. In step 417, the base station selects a communication mode based on the UE capability information, completing its connection to the mobile communication terminal.

Upon receiving a communication mode change request from the host 210 in step 419, the modem 230 informs the base station that the UE capability information has been updated in reply to the communication mode change request in step 421. For example, if the modem 230 has received from the host 210 a request to change the UE category to a category #1, one of the two antennas which were used is unused by being powered off, as the UE category is changed from the category #3 to the category #1. The changed category information (or updated UE capability information) may be transmitted to the base station through steps 413 and 415, or may be transmitted in a message indicating the update of the UE capability information.

In step 423, the mobile communication terminal and the base station change or reset the communication mode based on the updated UE capability. In step 425, the modem 230 informs the host 210 that the communication mode has been changed.

In an alternative embodiment of the present invention, the modem may change the communication mode used for communication with the base station depending on the characteristics of services used by the mobile communication terminal or the power status of the host, thereby saving power. In a case where the mobile communication terminal is powered by a battery and saving the battery is more important than maintaining the data bit rate due to the low battery level, the host may control the modem to use a communication mode in which less power is consumed, depending on a user's command or a predetermined policy, thereby reducing power consumption. Even in a case where services that do not require high-speed data transmission, such as Short Message Service (SMS), are used, the host may control the modem to use a low-power communication mode, making it possible to save power.

As is apparent from the foregoing description, in accordance with exemplary embodiments of the present invention, the modem excludes communication modes, in which its communication is impossible due to the lack of power, in selecting a communication mode by acquiring in advance suppliable power information from the host before negotiating over a communication mode with the base station, thereby making it possible to prevent the base station from selecting the unavailable communication mode during the negotiation over a communication mode with the base station. Besides, the host may restrict communication modes depending on the battery's remaining power and/or the situations of the host such as characteristics of the running S/W, at the sacrifice of the decrease in transfer rate, thereby contributing to a reduction in power consumption.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling power in a wireless communication system, the method comprising:
determining one or more available communication modes based on at least one of suppliable power information and data bit rate information;
setting one of the one or more determined available communication modes as a communication mode during negotiation of a communication mode with a base station; and
transmitting and receiving data by applying the set communication mode.

2. The method of claim 1, further comprising:
determining whether the set communication mode needs to be changed after the set communication mode is applied; and
resetting the communication mode used for communication with the base station if the set communication mode needs to be changed.

3. The method of claim 2, wherein the suppliable power information and the data bit rate information are acquired by at least one of type information, release version information, and power rail information of an interface, all of which are stored in advance.

4. The method of claim 2, wherein the suppliable power information and the data bit rate information are determined depending on at least one of interface type information, battery status information, and operation status information, and transmitted by a preset protocol.

5. The method of claim 2, wherein the resetting of the communication mode comprises blocking power supplied to remaining antennas except for antennas used in a new communication mode.

6. The method of claim 2, wherein whether the set communication mode needs to be changed is determined by a status of a terminal, which includes at least one of a transfer rate of an interface and a battery status of a host.

7. The method of claim 2, further comprising notifying the base station that the available communication modes have changed.

8. An apparatus for controlling power in a wireless communication system, the apparatus comprising:
a host for transmitting at least one of suppliable power information and data bit rate information to a modem; and
the modem for determining one or more available communication modes based on at least one of the transmitted suppliable power information and data bit rate information, for setting one of the one or more determined available communication modes as a communication mode during negotiation of a communication mode with a base station, and for transmitting and receiving data by applying the set communication mode.

9. The apparatus of claim 8, wherein the host determines whether the set communication mode needs to be changed, and requests the modem to change the set communication mode if the set communication mode needs to be changed.

10. The apparatus of claim 9, wherein the suppliable power information and the data bit rate information are acquired by at least one of type information, release version information, and power rail information of an interface, all of which are stored in advance.

11. The apparatus of claim 9, wherein the suppliable power information and the data bit rate information are determined depending on at least one of interface type information, battery status information, and operation status information, and transmitted by a preset protocol.

12. The apparatus of claim 11, wherein the host determines whether the set communication mode needs to be changed based on at least one of the interface type information, the battery status information, and the operation status information.

13. The apparatus of claim 8, wherein the modem blocks power supplied to remaining antennas except for antennas used in a new communication mode.

14. The apparatus of claim 9, wherein whether the set communication mode needs to be changed is determined by a status of a terminal, which includes at least one of a transfer rate of an interface and a battery status of a host.

15. The apparatus of claim 9, wherein the modem notifies the base station that the available communication modes have changed.
